(19) United States
(12) Patent Application Publication
(10) Pub. No.: US 2013/0294760 A1
(43) Pub. Date: Nov. 7, 2013

(54) IMAGING APPARATUS

(71) Applicant: PANASONIC CORPORATION, Osaka (JP)

(72) Inventors: Hironori HONSHO, Hyogo (JP); Hideyuki Hashi, Osaka (JP)

(21) Appl. No.: 13/929,685

(22) Filed: Jun. 27, 2013

Related U.S. Application Data
(63) Continuation of application No. PCT/JP2012/007640, filed on Nov. 28, 2011.

(30) Foreign Application Priority Data
Dec. 7, 2011 (JP) 2011-267978

(51) Int. Cl. G03B 17/02

(52) U.S. Cl. CPC G03B 17/02
USPC 396/535

(57) ABSTRACT

An imaging apparatus (100) includes a case (12) formed with an opening (12a) and having an inner spherical zone surface, and a camera body (2) configured to be movable inside the case (12) and to shoot an image of an object outside the case (12) through the opening (12a). A shooting range (S) of the camera body (2) is limited within the opening (12a).

### CROSS-REFERENCE TO RELATED APPLICATIONS

This is a continuation of International Application No. PCT/JP2012/007640 filed on Nov. 28, 2012, which claims priority to Japanese Patent Application No. 2011-267978 filed on Dec. 7, 2011. The entire disclosures of these applications are incorporated by reference herein.

### BACKGROUND

The technique disclosed herein relates to an imaging apparatus including an imager arranged inside a case having an inner spherical zone surface.

In an imaging apparatus described in Japanese Patent Publication No. H09-254838, an imager is arranged inside a spherical shell having an inner spherical zone surface. The spherical shell is divided into two parts. Such two parts are joined together in the state in which the imager is accommodated inside the two parts. In the imaging apparatus, the imager moves relative to the inner surface of the spherical shell. This allows shooting while adjusting an imaging range. More specifically, the imager includes three drive wheels, and the drive wheels contact the inner surface of the spherical shell. In such a manner that the drive wheels are driven, the imager moves along the inner surface of the spherical shell. The imager shoots, through the spherical shell, an image of an object outside the spherical shell.

### SUMMARY

However, in the imaging apparatus described in Japanese Patent Publication No. H09-254838, a joint, i.e., a dividing line, of the spherical shell may be within the imaging range of the imager. In such a case, there is a possibility that an image quality is degraded due to, e.g., unexpected appearance of the joint in a shot image.

The technique disclosed herein has been made in view of the foregoing, and is directed to reduce degradation of an image quality in an imaging apparatus in which an imager is arranged inside a case having an inner spherical zone surface.

The technique disclosed herein is intended for an imaging apparatus for shooting an image of an object. The imaging apparatus includes a case formed with an opening and having an inner spherical zone surface; and an imager configured to be movable inside the case and to shoot the image of the object outside the case through the opening. A shooting range of the imager is controlled within the opening.

According to the technique disclosed herein, degradation of an image quality can be reduced.

### BRIEF DESCRIPTION OF THE DRAWINGS

FIG. 1 is a perspective view of an imaging apparatus.

FIGS. 2A and 2B are cross-sectional views of the imaging apparatus. FIG. 2A is the cross-sectional view of the imaging apparatus along a plane passing through the center of an outer shell and being perpendicular to a P axis. FIG. 2B is the cross-sectional view of the imaging apparatus along a B-B line illustrated in FIG. 2A.

FIGS. 3A and 3B illustrate a camera body. FIG. 3A is a perspective view of the camera body. FIG. 3B is a front view of the camera body.

FIG. 4 is an exploded perspective view of a movable frame and first to third drivers.

FIG. 5 is a functional block diagram of the imaging apparatus.

FIG. 6 is a flowchart of a drive control.

FIG. 7 is a view illustrating rotation restriction of the camera body.

FIG. 8 is a view illustrating a usage example of the imaging apparatus.

### DETAILED DESCRIPTION

An embodiment is described in detail below with reference to the attached drawings. However, unnecessarily detailed description may be omitted. For example, detailed description of well known techniques or description of the substantially same elements may be omitted. Such omission is intended to prevent the following description from being unnecessarily redundant and to help those skilled in the art easily understand it.

Inventor(s) provides the following description and the attached drawings to enable those skilled in the art to fully understand the present disclosure. Thus, the description and the drawings are not intended to limit the scope of the subject matter defined in the claims.

### 1. External Appearance

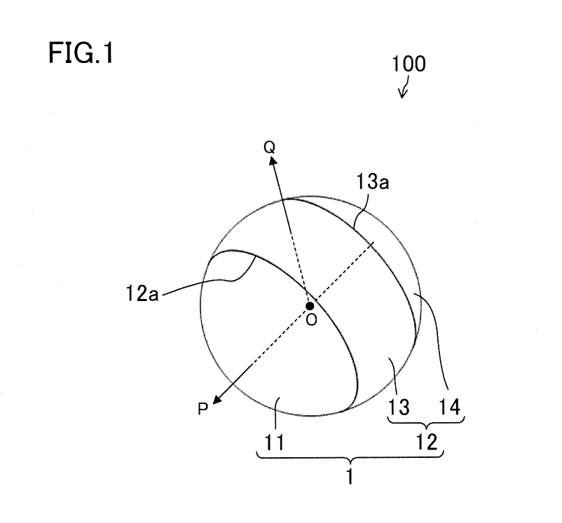

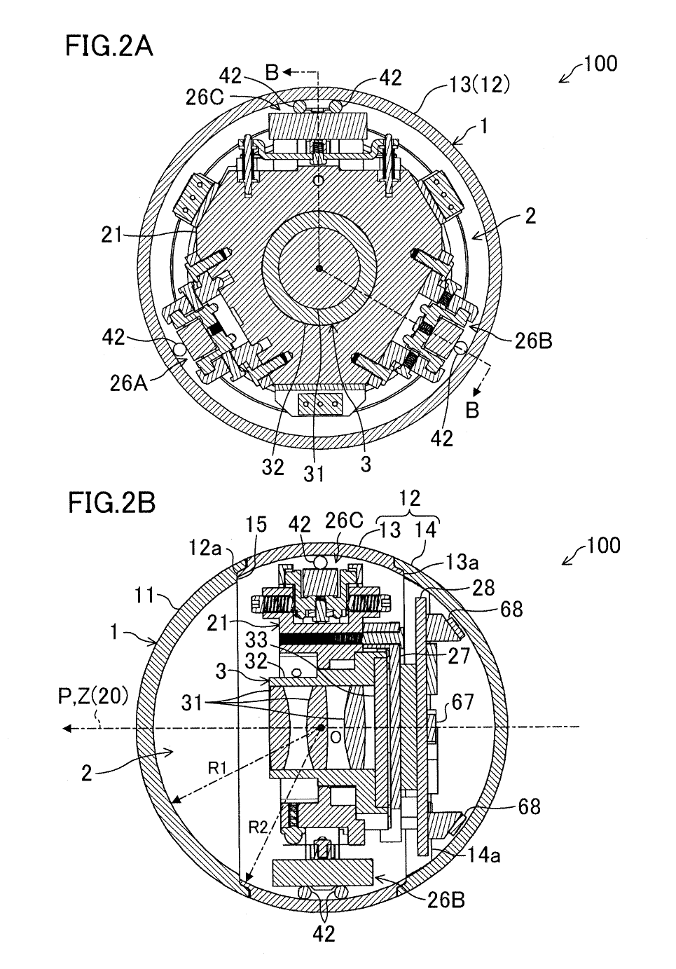

FIG. 1 is a perspective view of an imaging apparatus 100. FIGS. 2A and 2B are cross-sectional views of the imaging apparatus 100. FIG. 2A is the cross-sectional view of the imaging apparatus 100 along a plane passing through the center O of an outer shell 1 and being perpendicular to a P axis, and FIG. 2B is the cross-sectional view of the imaging apparatus 100 along a B-B line illustrated in FIG. 2A.

The imaging apparatus 100 includes the substantially spherical outer shell 1 and a camera body 2 arranged inside the outer shell 1. The camera body 2 moves relative to the outer shell 1 along an inner surface of the outer shell 1. While moving inside the outer shell 1, the camera body 2 shoots, through the outer shell 1, an image of an object outside the outer shell 1.

### 2. Outer Shell

The outer shell 1 includes a cover 11 and a case 12. The cover 11 and the case 12 are joined together, thereby forming a substantially spherical shape. The outer shell 1 has a substantially spherical inner surface.

The cover 11 is formed in a spherical-sector shape so as not to have the great circle of the outer shell 1. An inner surface of the cover 11 has the substantially same curvature as that of an inner surface of the case 12. The cover 11 is made of acrylic resin transparent to visible light. The light transmittance of the cover 11 is higher than that of the case 12. The “spherical sector” means a “spherical zone” formed with only one opening.

The case 12 is formed in a spherical-sector shape so as to have the great circle of the outer shell 1. The case 12 is formed with an opening 12a, and is formed so as to have an inner spherical zone surface. The cover 11 is joined at the opening 12a. The case 12 is divided into a first case 13 and a second case 14.

The first case 13 is formed in a spherical-zone shape so as to have the great circle of the outer shell 1, and the first case 13 is formed with two openings 12a, 13a. The openings 12a, 13a each form a small circle of the outer shell 1, and are parallel to the great circle of the outer shell 1. Moreover, the openings 12a, 13a have the same diameter. That is, the distance between the opening 12a and the great circle is identical to that between the opening 13a and the great circle. The opening 12a is an opening of the case 12, and the cover 11 is, as described above, joined to the case 12 at the opening 12a. On the other hand, the second case 14 is joined to the case 12 at the opening 13a. The first case 13 is formed so as to have an inner spherical zone surface. The first case 13 is made of a high hardness material (e.g., a material having hardness higher than that of the cover 11) such as a ceramic material. This can reduce abrasion due to contact with a driver element 42 which will be described later.

The second case 14 is formed in a spherical-sector shape so as not to have the great circle of the outer shell 1. The second case 14 is formed so as to have an inner spherical sector surface. The second case 14 is made of polycarbonate resin. A reflective film 14a by which infrared light is reflected is formed on the inner surface of the second case 14. Specifically, the reflective film 14a is formed in a spherical-zone shape at an opening edge part of the second case 14 on the inner surface thereof.

Referring to FIG. 1, the center point (i.e., the center of the first case 13) of the outer shell 1 is defined as an “O point” a straight line passing through the O point and the centers of the two openings of the first case 13 is defined as a “P axis,” and an axis passing through the O point so as to be perpendicular to the P axis is defined as a “Q axis.”

### 3. Camera Body

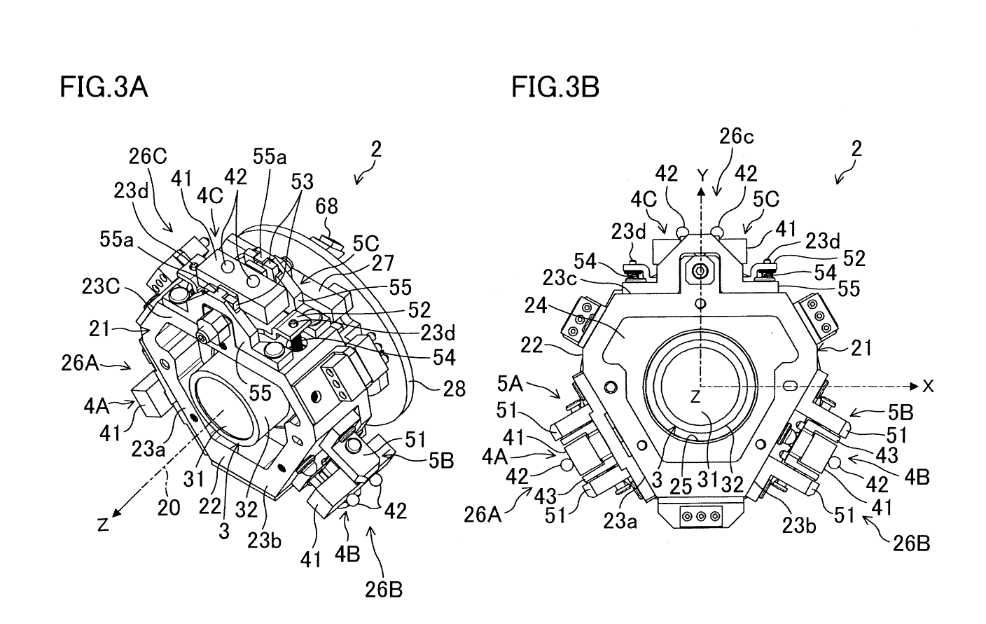

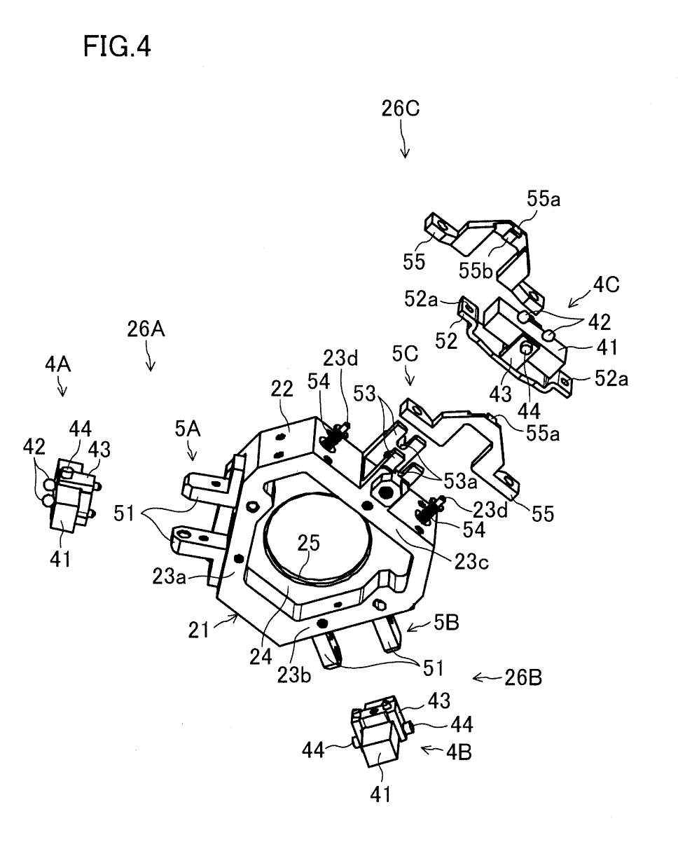

FIGS. 3A and 3B illustrate the camera body 2. FIG. 3A is a perspective view of the camera body 2, and FIG. 3B is a front view of the camera body 2. FIG. 4 is an exploded perspective view of a movable frame 21 and first to third drivers 26A-26C.

The camera body 2 includes the movable frame 21, a lens barrel 3, the first to third drivers 26A-26C attached to the movable frame 21, an attachment plate 27 configured to attach the lens barrel 3 to the movable frame 21, and a circuit board 28 configured to control the camera body 2. The camera body 2 can shoot still images and moving pictures. An optical axis 20 of the lens barrel 3 is referred to as a “Z axis,” and a side close to an object relative to the optical axis 20 is a front side. The camera body 2 is one example of an imager.

The movable frame 21 is a substantially equilateral-triangular frame body as viewed from the front. The movable frame 21 includes an outer peripheral wall 22 which has first to third side walls 23a-23c forming three sides of the triangle, and a dividing wall 24 formed inside the outer peripheral wall 22. An opening 25 is formed at the center of the dividing wall 24.

The lens barrel 3 includes a plurality of lenses 31 having the optical axis 20, a lens frame 32 configured to hold the lenses 31, and an imaging device 33. The lens frame 32 is arranged inside the movable frame 21, and the optical axis 20 passes through the center of the movable frame 21. The attachment plate 27 is provided on a back side of the imaging device 33 of the lens barrel 3 (see FIG. 2B). The lens barrel 3 is attached to the movable frame 21 through the attachment plate 27. The circuit board 28 is attached to the attachment plate 27 on a side opposite to the lens barrel 3.

The first to third drivers 26A-26C are provided on an outer peripheral surface of the movable frame 21. Specifically, the first driver 26A is provided on the first side wall 23a. The second driver 26B is provided on the second side wall 23b. The third driver 26C is provided on the third side wall 23c. The first to third drivers 26A-26C are arranged about the Z axis at substantially equal intervals, i.e., at about every 120°. Referring to FIG. 3B, an axis passing through the third driver 26C so as to be perpendicular to the Z axis is referred to as a “Y axis,” and an axis perpendicular to both of the Z and Y axes is referred to as an “X axis.”

The first driver 26A includes an actuator body 4A and a first support mechanism 5A. The second driver 26B includes an actuator body 4B and a second support mechanism 5B. The third driver 26C includes an actuator body 4C and a third support mechanism 5C.

The actuator bodies 4A-4C have the same configuration. Only the actuator body 4A will be described below, and the description of the actuator bodies 4B, 4C will not be repeated. The actuator body 4A includes an oscillator 41, two driver elements 42 attached to the oscillator 41, and a holder 43 configured to hold the oscillator 41.

The oscillator 41 is a piezoelectric device made of multilayer ceramic. The oscillator 41 is formed in a substantially rectangular parallelepiped shape. In such a manner that predetermined drive voltage (alternating voltage) is applied to an electrode (not shown in the figure) of the oscillator 41, the oscillator 41 harmonically generates stretching vibration in a longitudinal direction of the oscillator 41 and bending vibration in a transverse direction of the oscillator 41.

The driver elements 42 are, on one side surface of the oscillator 41, arranged in the longitudinal direction of the oscillator 41. The driver element 42 is a ceramic spherical body, and is bonded to the oscillator 41. The stretching vibration and the bending vibration of the oscillator 41 generates elliptic motion of each of the driver elements 42. By the elliptic motion of the driver elements 42, drive force in the longitudinal direction of the oscillator 41 is output.

The holder 43 is made of polycarbonate resin containing glass. The holder 43 sandwiches the oscillator 41 from both sides in a layer stacking direction (i.e., a direction perpendicular to both of the longitudinal and transverse directions) of the oscillator 41. The holder 43 is bonded to the oscillator 41. In the holder 43, a rotary shaft 44 extending in the layer stacking direction of the oscillator 41 is provided so as to outwardly protrude.

The first support mechanism 5A includes two L-shaped brackets 51. The brackets 51 are screwed to an outer surface of the first side wall 23a. The brackets 51 rotatably support the rotary shaft 44 of the holder 43 with the actuator body 4A being sandwiched between the brackets 51. Thus, the actuator body 4A is supported by the first support mechanism 5A so as to rotate about an axis which is parallel to a plane perpendicular to the Z axis and which is parallel to the first side wall 23a. In such a state, the driver elements 42 of the actuator body 4A are arranged parallel to the Z axis.

The second support mechanism 5B has a configuration similar to that of the first support mechanism 5A, and includes two L-shaped brackets 51. The brackets 51 are screwed to an outer surface of the second side wall 23b. The brackets 51 rotatably support the rotary shaft 44 of the holder 43 with the actuator body 4B being sandwiched between the brackets 51. Thus, the actuator body 4B is supported by the second support mechanism 5B so as to rotate about the axis which is parallel to the plane perpendicular to the Z axis and which is parallel to the second side wall 23b. In such a state, the driver elements 42 of the actuator body 4B are arranged parallel to the Z axis.

The third support mechanism 5C includes a holding plate 52 attached to the holder 43, two supports 53 configured to support the rotary shaft 44 of the actuator body 4C, two biasing springs 54, and stoppers 55 configured to restrict movement of the rotary shaft 44. The holding plate 52 is screwed to the holder 43. The holding plate 52 is a plate-shaped member extending in the longitudinal direction of the oscillator 41, and an opening 52a is formed in each end part of the holding plate 52. A tip end of a pin 23d which will be described later is inserted into the opening 52a. The supports 53 are arranged parallel to a Z-axis direction on the third side wall 23c. A guide groove 53a engaged with the rotary shaft 44 is formed at a tip end of the support 53. The guide groove 53a extends in a direction perpendicular to the Z axis. The rotary shaft 44 of the holder 43 is fitted into the guide grooves 53a so as to move back and forth in a longitudinal direction of the guide groove 53a and to rotate about an axis of the rotary shaft 44. Each tip end of the rotary shaft 44 protrudes beyond the support 53 in the Z-axis direction. Two pins 23d are provided on an outer surface of the third side wall 23c. The biasing spring 54 is fitted onto the pin 23d. The stopper 55 includes a first restrictor 55a configured to restrict movement of the rotary shaft 44 in the longitudinal direction (i.e., a direction in which the guide groove 53a extends) of the guide groove 53a, and a second restrictor 55b configured to restrict movement of the rotary shaft 44 in a direction parallel to the Z axis. The stoppers 55 are screwed to the third side wall 23c. In the state in which the stoppers 55 are attached to the third side wall 23c, each of the first restrictors 55a is fitted into a tip end of the guide groove 53a (see FIG. 3A). In the state in which the stoppers 55 are attached to the third side wall 23c, each of the second restrictors 55b is arranged at a position facing the tip end of the rotary shaft 44 engaged with the guide grooves 53a.

In the third support mechanism 5C configured as described above, the actuator body 4C is mounted in the supports 53 such that the rotary shaft 44 of the holder 43 is fitted into the guide grooves 53a. The holding plate 52 and the third side wall 23c sandwich the biasing springs 54, thereby compressing and deforming the biasing springs 54. In such a state, the stoppers 55 are screwed to the third side wall 23c. The actuator body 4C is, by elastic force of the biasing springs 54, biased toward a side apart from the Z axis in the direction perpendicular to the Z axis. Since each of the tip ends of the guide grooves 53a is closed by the first restrictor 55a of the stopper 55, the rotary shaft 44 is prevented from being detached from the guide grooves 53a. Moreover, since each of the second restrictors 55b of the stoppers 55 is arranged at the position facing the tip end of the rotary shaft 44, movement of the actuator body 4C in the Z-axis direction is restricted by the second restrictors 55b. That is, the actuator body 4C is supported by the third support mechanism 5C so as to move in the longitudinal direction of the guide groove 53a and to rotate about the rotary shaft 44.

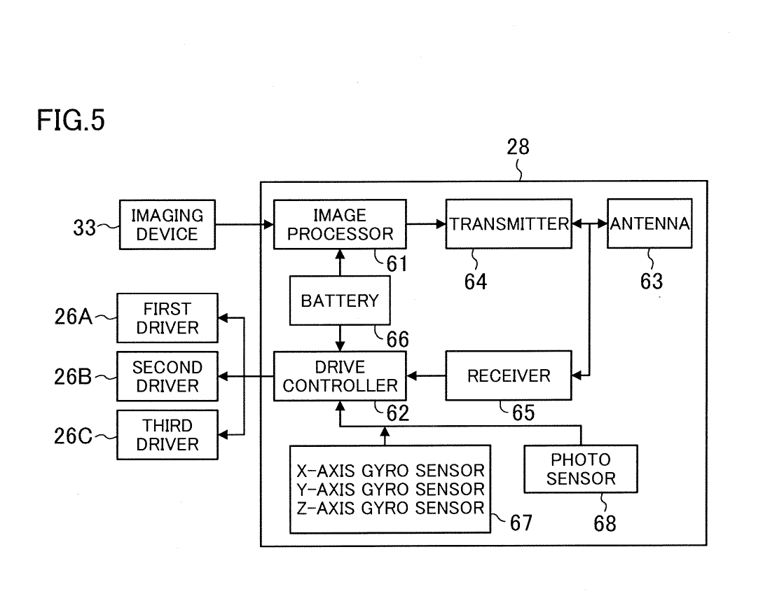

FIG. 5 is a functional block diagram of the imaging apparatus 100. The circuit board 28 includes an image processor 61 configured to perform video signal processing based on an output signal from the imaging device 33, a drive controller 62 configured to control driving of the first to third drivers 26A-26C, an antenna 63 configured to transmit/receive a wireless signal, a transmitter 64 configured to convert a signal from the image processor 61 into a transmission signal to transmit the transmission signal through the antenna 63, a receiver 65 configured to receive a wireless signal through the antenna 63 and to convert the wireless signal to output the converted signal to the drive controller 62, a battery 66, a gyro sensor 67 configured to detect the angular velocity of the camera body 2, and three photo sensors 68 configured to detect the position of the camera body 2.

The gyro sensor 67 is for three detection axes. That is, the gyro sensor 67 is a sensor package including an X-axis gyro sensor configured to detect a rotation angular velocity about the X axis, a Y-axis gyro sensor configured to detect a rotation angular velocity about the Y axis, and a Z-axis gyro sensor configured to detect a rotation angular velocity about the Z axis. The gyro sensor 67 is configured to output a signal corresponding to an angular velocity about each of the detection axes. Rotational movement of the camera body 2 can be detected based on an output signal of the gyro sensor 67.

The photo sensor 68 includes a light emitter (not shown in the figure) configured to output infrared light, and a light receiver (not shown in the figure) configured to receive infrared light. The photo sensor 68 is configured to emit/receive infrared light having a wavelength of 900 nm. Since an IR cut filter is provided in the front of the imaging device 33, unexpected appearance of unnecessary light in a shot image due to infrared light from the photo sensors 68 can be reduced or prevented. The photo sensors 68 are, at different positions, arranged on a surface of the circuit board 28 opposite to the movable frame 21. Each of the photo sensors 68 is arranged so as to output infrared light toward the inner surface of the outer shell 1 and to receive light reflected by the inner surface. Although details will be described later, the position of the camera body 2 inside the outer shell 1 can be detected based on output signals of the photo sensors 68.

The image processor 61 is configured to perform, e.g., amplification and A/D conversion of an output signal of the imaging device 33. The drive controller 62 is configured to output drive voltage (i.e., a control signal) to each of the first to third drivers 26A-26C. The drive controller 62 generates drive voltage based on a signal (command) input from the outside through the antenna 63 and the receiver 65, an output signal of the gyro sensor 67, and output signals of the photo sensors 68.

### 4. Arrangement of Camera Body inside Outer Shell

Referring to FIGS. 2A and 2B, the camera body 2 is arranged inside the case 12 of the outer shell 1. The state in which the Z axis of the camera body 2 and the P axis of the outer shell 1 are coincident with each other is referred to as a “reference state.” That is, FIGS. 2A and 2B illustrate the reference state of the imaging apparatus 100. Each of the driver elements 42 of the first to third drivers 26A-26C contacts an inner surface of the first case 13. The lens barrel 3 faces the cover 11, and the camera body 2 shoots an image of an object outside the case 12 through the opening 12a. The circuit board 28 is positioned inside the second case 14 in the reference state. The third driver 26C is movable in a radial direction about the Z axis, and is biased toward the outside in the radial direction by the biasing springs 54. Thus, the driver elements 42 of the third driver 26C contact the inner surface of the first case 13 in the state in which the driver elements 42 are pressed against the inner surface of the first case 13 by elastic force of the biasing springs 54. The driver elements 42 of the first and second drivers 26A, 26B contact the inner surface of the first case 13 in the state in which the driver elements 42 are pressed against the inner surface of the first case 13 by reactive force of the biasing springs 54. In the reference state, the driver elements 42 of the first driver 26A are arranged parallel to the P axis. The driver elements 42 of the second driver 26B are arranged parallel to the P axis. On the other hand, the driver elements 42 of the third driver 26C are arranged in a circumferential direction of the great circle of the outer shell 1, i.e., in a circumferential direction about the P axis. The actuator body 4C of the third driver 26C is movable in the radial direction about the Z axis, and each of the actuator bodies 4A-4C of the first to third drivers 26A-26C is supported so as to rotate about the rotary shaft 44. Thus, e.g., a shape error of the inner surface of the first case 13 and an assembly error of each of the drivers are absorbed.

The photo sensors 68 are provided on the surface of the circuit board 28 opposite to the movable frame 21. The photo sensors 68 are arranged about the Z axis at about every 120°, and the circumferential positions of the photo sensors 68 about the Z axis are substantially coincident respectively with the first to third drivers 26A-26C. In the reference state, the photo sensors 68 face the inner surface of the second case 14, but do not face the reflective film 14a. Note that the photo sensors 68 do not contact the inner surface of the second case 14.

The reflective film 14a is formed at the opening edge part of the second case 14 on the inner surface thereof The reflective film 14a is in such an aspherical shape that the radius about the center O of the outer shell 1 decreases with approach toward an opening edge of the second case 14 (i.e., toward the first case 13). That is, the distance between the photo sensor 68 and the reflective film 14a is shortened toward the opening edge of the second case 14. The photo sensor 68 is configured to output a detection signal corresponding to the distance between the photo sensor 68 and the reflective film 14a. Thus, it can be, based on the detection signal, determined how close the photo sensor 68 is to the opening edge of the second case 14, and therefore the inclination of the Z axis of the camera body 2 relative to the P axis of the outer shell 1 can be obtained.

The curvature radius R1 of the inner surface of the cover 11 is less than the curvature radius R2 of the inner surface of the first case 13. That is, a step 15 is formed at a boundary between the cover 11 and the first case 13 on the inner surface of the outer shell 1. Although details will be described later, movement of the camera body 2 is restricted by contact of part of the camera body 2 with the step 15. The step 15 is an example of a restrictor.

### 5. Operation of Camera Body

When drive voltage is applied to the first to third drivers 26A-26C, elliptic motion of each of the driver elements 42 of the first to third drivers 26A-26C is generated. Upon the elliptic motion of the driver elements 42, the first driver 26A outputs drive force in the direction parallel to the Z axis. The second driver 26B outputs drive force in the direction parallel to the Z axis. The third driver 26C outputs drive force in a circumferential direction about the Z axis. Thus, the drive force of the first driver 26A and the drive force of the second driver 26B can be combined together, thereby arbitrarily adjusting the inclination of the Z axis of the camera body 2 relative to the P axis of the outer shell 1. Moreover, the camera body 2 can rotate about the Z axis by the drive force of the third driver 26C. As in the foregoing, in such a manner that the drive force of the first to third drivers 26A-26C is adjusted, the camera body 2 can rotationally move relative to the outer shell 1, and the attitude of the camera body 2 on the outer shell 1 can be arbitrarily adjusted.

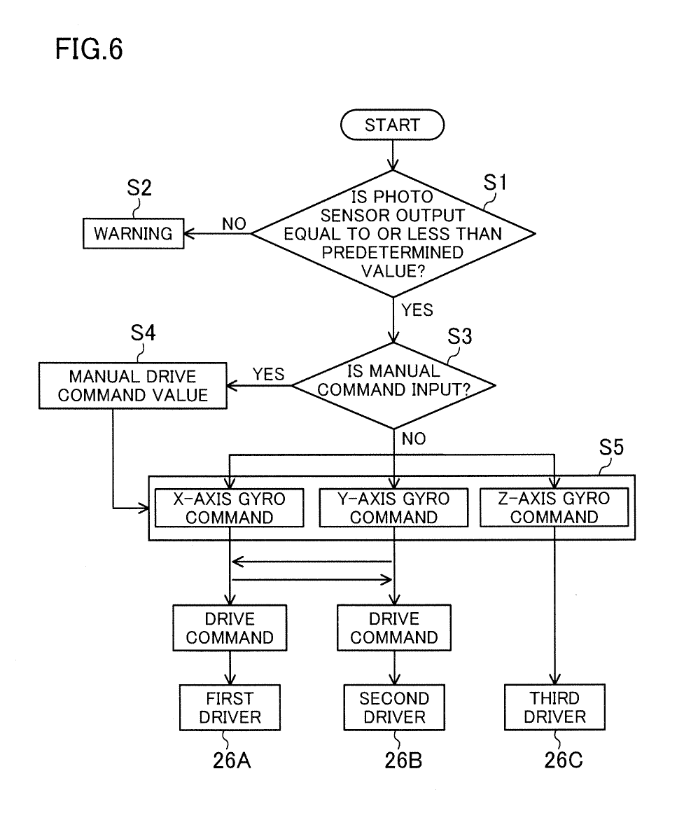

FIG. 6 is a flowchart of a drive control.

First, the drive controller 62 determines, at step S1, whether or not each output of the photo sensors 68 is equal to less than a predetermined set value. If at least one of the outputs of the photo sensors 68 exceeds the set value, the drive controller 62 outputs a warning command at step S2.

Specifically, the drive controller 62 controls a rotation range of the camera body 2 based on each output of the photo sensors 68. The reflective film 14a is, as described above, formed such that the radius about the center O of the outer shell 1 decreases with approach toward the opening edge of the second case 14. Moreover, the closer the photo sensor 68 gets to an object by which the output is reflected, i.e., the reflective film 14a, the larger the output of the photo sensor 68 is. That is, the drive controller 62 can determine, based on each output of the photo sensors 68, how close the photo sensor 68 is to the opening edge of the second case 14. The closer the photo sensor 68 gets to the opening edge of the second case 14, the greater the inclination of the optical axis 20 relative to the P axis of the outer shell 1 is. In such a manner that each output of the photo sensors 68 is limited at equal to or less than the predetermined set value, the rotation range of the camera body 2 is limited within a predetermined range. The rotation range of the camera body 2 will be described later.

The warning command is input to, e.g., a speaker (not shown in the figure) provided in the imaging apparatus 100. The speaker is configured to output predetermined sound. Alternatively, the drive controller 62 may perform wireless communication of the warning command with an external device (not shown in the figure) through the antenna 63.

If all outputs of the photo sensors 68 are equal to or less than the set value, the drive controller 62 determines, at step S3, whether or not a manual command is input from the outside through wireless communication. The manual command is, e.g., a command to follow a particular object or a command to perform panning (i.e., rotation about the Y axis), tilting (i.e., rotation about the X axis), or rolling (i.e., rotation about the Z axis) of the camera body 2 at a predetermined angle. If the manual command is input, the drive controller 62 proceeds to step S4. On the other hand, if no manual command is input, the drive controller 62 proceeds to step S5.

At step S4, the drive controller 62 generates a manual drive command value based on the manual command. The manual drive command value is a command value for each of the first to third drivers 26A-26C. Subsequently, the process proceeds to step S5.

At step S5, the drive controller 62 generates, based on output of the gyro sensor 67, a command value for canceling rotation of the camera body 2 due to disturbance. Specifically, the drive controller 62 generates, based on a detection signal of the gyro sensor 67, a command value (hereinafter referred to as an “X-axis gyro command value”) for rotation about the X axis, a command value (hereinafter referred to as a “Y-axis gyro command value”) for rotation about the Y axis, and a command value (hereinafter referred to as a “Z-axis gyro command value”) for rotation about the Z axis such that rotation about the X, Y, and Z axes of the camera body 2 is canceled. The X-axis gyro command value and the Y-axis gyro command value are synthesized at a predetermined rate, thereby generating a drive command value to be output to the first driver 26A. Moreover, the X-axis gyro command value and the Y-axis gyro command value are synthesized at a predetermined rate, thereby generating a drive command value to be output to the second driver 26B. The Z-axis gyro command value is output to the third driver 26C as a drive command value. If the manual drive command value is generated, a final drive command value is generated by adding the manual drive command value to a drive command value obtained based on the gyro command value. The drive controller 62 applies drive voltage corresponding to the generated drive command value to each of the first to third drivers 26A-26C.

As a result, if no manual command is input, the first to third drivers 26A-26C are operated such that disturbance acting on the camera body 2 is canceled, and therefore the attitude of the camera body 2, i.e., the direction of the optical axis 20, is maintained constant. On the other hand, if the manual command is input, the first to third drivers 26A-26C are operated such that disturbance acting on the camera body 2 is canceled and that the camera body 2 moves according to the manual command.

Since shaking of the camera body 2 upon rotation thereof is, regardless of presence/absence of the manual command, reduced based on an output of the gyro sensor 67, blurring of a shot image is reduced. Moreover, the image processor 61 detects a motion vector of a moving picture and performs, by image processing, electronic correction of an image blur based on the motion vector. That is, in the imaging apparatus 100, a relatively-large image blur with a low frequency is reduced by controlling the attitude of the camera body 2, and a relatively-small image blur with a high frequency is corrected by electronic correction of the image processor 61.

### 6. Restriction of Rotation of Camera Body

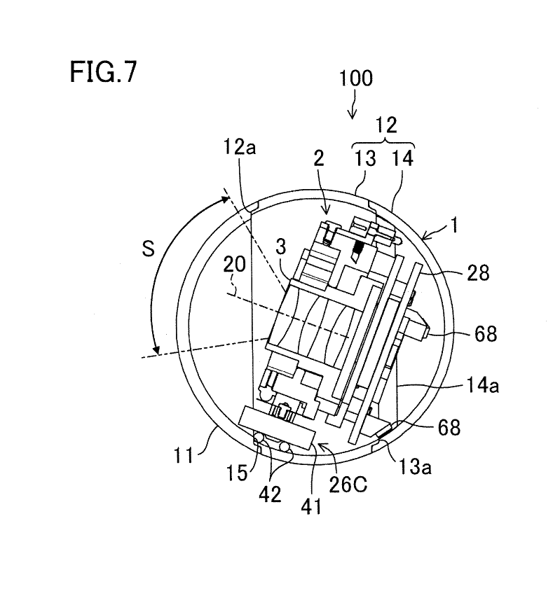

FIG. 7 is a cross-sectional view of the imaging apparatus 100 in the state in which rotation of the camera body 2 is restricted by the step 15.

Basically, the drive controller 62 controls, based on each output of the photo sensors 68, the rotation range of the camera body 2 such that a shooting range S of the camera body 2 is controlled within the opening 12a of the case 12 and that the driver elements 42 of the first to third drivers 26A-26C contact the inner surface of the case 12 and do not contact the inner surface of the cover 11.

That is, in the camera body 2, the lens barrel 3 has a specific shooting range S. The shooting range S is smaller than the opening 12a of the case 12. When the camera body 2 rotates to change the direction of the optical axis 20, the shooting range S is also shifted together with the optical axis 20. Upon large rotation of the camera body 2, an opening edge of the opening 12a of the case 12 may enter the shooting range S, resulting in unexpected appearance of the opening edge of the opening 12a in a shot image. For such a reason, the rotation range of the camera body 2 is controlled such that the shooting range S of the camera body 2 is controlled within the opening 12a of the case 12 (i.e., within the cover 11), and therefore degradation of a shot image can be reduced. That is, a movement track of the shooting range S in association with movement of the camera body 2 is controlled within the opening 12a of the case 12 (i.e., within the cover 11).

In the reference state, the driver elements 42 of the first to third drivers 26A-26C contact the inner surface of the case 12. However, upon large rotation of the camera body 2, there is a possibility that the driver element(s) 42 enters the cover 11 along the inner surface thereof. When the driver element(s) 42 enters the cover 11 along the inner surface thereof, there is a possibility that abrasion marks are formed on the inner surface of the cover 11 by the driver element(s) 42, resulting in unexpected appearance of the abrasion marks in a shot image. For such a reason, the rotation range of the camera body 2 is controlled such that each of the driver elements 42 does not contact the inner surface of the cover 11, and therefore degradation of a shot image can be reduced. That is, the rotation range of the camera body 2 is controlled such that each of the driver elements 42 does not enter a region defined by the movement track of the shooting range S in association with movement of the camera body 2.

In the present embodiment, the rotation range of the camera body 2 in which each of the driver element(s) 42 does not contact the inner surface of the cover 11 is smaller than the rotation range of the camera body 2 in which the shooting range S of the camera body 2 is controlled within the opening 12a of the case 12. Thus, while the rotation range of the camera body 2 is controlled such that each of the driver elements 42 does not contact the inner surface of the cover 11, the rotation range of the camera body 2 can be controlled such that the shooting range S of the camera body 2 is controlled within the opening 12a of the case 12. That is, the set value for each output of the photo sensors 68 is set at such a value that each of the driver elements 42 does not contact the inner surface of the cover 11. Thus, formation of abrasion marks on the inner surface of the cover 11 and unexpected appearance of abrasion marks or the opening edge of the opening 12a in a shot image can be reduced or prevented.

In addition to the foregoing electrical rotation restriction, rotation is also mechanically restricted in the imaging apparatus 100. Specifically, the step 15 is provided at a boundary between the cover 11 and the case 12 on the inner surface of the outer shell 1. Even if the driver element(s) 42 moves toward the cover 11 along the inner surface of the case 12, the driver element(s) 42 comes into contact with the step 15, and therefore the driver element(s) 42 is prevented from entering the cover 11 along the inner surface thereof. When extremely-large rotary force or impact force is applied to the imaging apparatus 100, there is a possibility that rotation of the camera body 2 cannot be restricted only by the foregoing electrical rotation restriction. However, since movement of the driver elements 42 is restricted by the step 15, rotation of the camera body 2 can be restricted even if extremely-large rotary force or impact force is applied to the imaging apparatus 100.

In the present embodiment, the distance between the opening 12a and the great circle is identical to the distance between the opening 13a and the great circle. Thus, restriction for preventing each of the driver elements 42 from entering the cover 11 allows restriction for preventing each of the driver elements 42 from entering the second case 14. That is, when one of the driver elements 42 approaches the cover 11, at least one of the remaining driver elements 42 approaches the second case 14. Moreover, the first case 13 has a shape symmetric with respect to a plane including the great circle of the outer shell 1. Thus, restriction for preventing one of the driver elements 42 from entering the cover 11 can prevent the remaining driver elements 42 from entering the second case 14. That is, rotation of the camera body 2 is controlled such that the driver elements 42 move inside the first case 13 along the inner surface thereof.

### 7. Usage Example of Imaging Apparatus

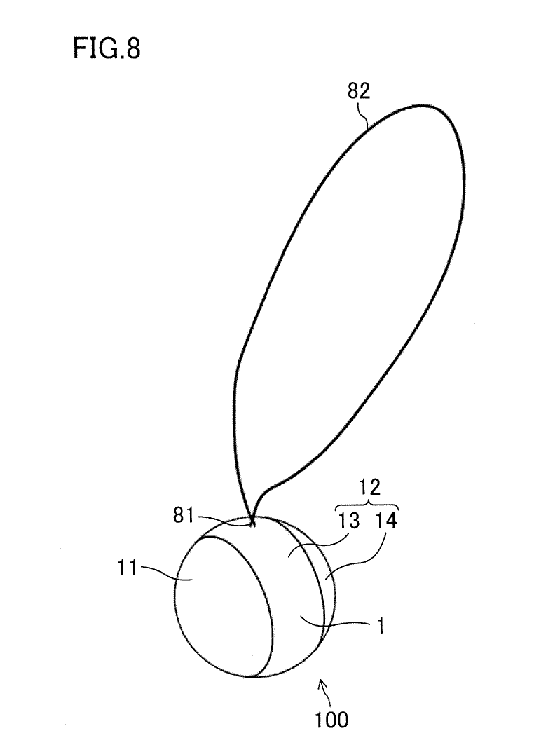

FIG. 8 illustrates a usage example of the imaging apparatus 100.

A pin 81 is provided on an outer surface of the first case 13. A strap 82 is attached to the pin 81. A hook-and-loop fastener (not shown in the figure) is provided on an outer surface of the second case 14.

A user wears the strap 82 around a neck, and uses the imaging apparatus 100 with the imaging apparatus 100 being hung from the neck. In such a state, the hook-and-loop fastener is attached to, e.g., clothes, thereby reducing or preventing large shaking of the imaging apparatus 100 during walking etc.

The camera body 2 can be operated in panning, tilting, and rolling directions by a wireless communication device such as a smart phone. Moreover, image blurring during walking can be reduced by the gyro sensor 67.

### 8. Advantages

Thus, the imaging apparatus 100 includes the case 12 formed with the opening 12a and having the inner spherical zone surface, and the camera body 2 configured to be movable inside the case 12 and to shoot an image of an object outside the case 12 through the opening 12a. The shooting range S of the camera body 2 is limited within the opening 12a.

According to such a configuration, the opening edge of the opening 12a is prevented from entering the shooting range S of the camera body 2. As a result, degradation of an image quality due to unexpected appearance of the opening edge of the opening 12a in a shot image can be reduced or prevented.

The imaging apparatus 100 further includes the cover 11 covering the opening 12a. The camera body 2 is configured to move inside the case 12 in a state in which the camera body 2 contacts the inner surface of the case 12, and movement of the camera body 2 is limited within such a range that the camera body 2 does not contact the inner surface of the cover 11.

According to such a configuration, the camera body 2 is prevented from contacting the inner surface of the cover 11. If the camera body 2 contacts the inner surface of the cover 11, abrasion marks may be formed on the inner surface of the cover 11. The camera body 2 shoots an image of an object outside the case 12 through the cover 11. Thus, if there are abrasion marks on the cover 11, the abrasion marks unexpectedly appear in a shot image. In such a manner that the camera body 2 does not contact the inner surface of the cover 11, formation of abrasion marks on the cover 11 can be reduced or prevented, and therefore degradation of an image quality due to the abrasion marks can be reduced or prevented.

The imaging apparatus 100 further includes the step 15 configured to restrict movement of the camera body 2 such that the camera body 2 does not contact the inner surface of the cover 11.

According to such a configuration, movement of the camera body 2 is mechanically restricted by the step 15. For example, in the case of electrical movement restriction of the camera body 2, when extremely-large external force acts on the imaging apparatus 100, there is a possibility that movement of the camera body 2 cannot be limited within a predetermined range. In such a manner that the step 15 which is the restrictor configured to perform mechanical restriction is provided, movement of the camera body 2 can be mechanically restricted. As a result, even if extremely-large external force acts on the imaging apparatus 100, movement of the camera body 2 can be limited within the predetermined range.

The imaging apparatus 100 further includes the cover 11 covering the opening 12a. The light transmittance of the cover 11 is higher than that of the case 12.

According to such a configuration, even in the configuration in which an image is shot through the cover 11, degradation of a shot image can be reduced.

The inner surface of the cover 11 defines the spherical-sector shape having the curvature substantially identical to that of the inner surface of the case 12.

### Other Embodiment

As described above, the foregoing embodiment has been described as example techniques disclosed in the present application. However, the techniques according to the present disclosure are not limited to the foregoing embodiment, but are also applicable to those where modifications, substitutions, additions, and omissions are made. In addition, elements described in the foregoing embodiment may be combined to provide a different embodiment. As such, elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential.

The foregoing embodiment may have the following configurations.

The imaging apparatus 100 shoots still images and moving pictures. However, the imaging apparatus 100 may shoot only still images or moving pictures.

The imaging apparatus 100 includes the cover 11, but may not include the cover 11. Moreover, the case 12 includes the first case 13 and the second case 14, but the configuration of the case 12 is not limited to such a configuration.

The first to third drivers 26A-26C are vibration actuators each including a piezoelectric device, but are not limited to such actuators. For example, the driver may include a stepping motor and a drive wheel, and may be configured such that the drive wheel contacts the inner surface of the case 12.

The first to third drivers 26A-26C are arranged about the Z axis at equal intervals, but are not necessarily arranged at equal intervals. Moreover, the number of drivers is not limited to three, and may be two or less or four or more. For example, if the imaging apparatus 100 includes four drivers, the four drivers may be arranged at equal intervals (i.e., at every 90°).

In the foregoing embodiment, the rotation range of the camera body 2 is limited by the photo sensors 68 and the step 15. However, the present disclosure is not limited to such a configuration. For example, the drive controller 62 may limit the rotation range of the camera body 2 by storing an original position, such as the reference state, of the camera body 2 and limiting the amount of movement from the original position. Moreover, any one of the configuration in which rotation of the camera body 2 is electrically restricted or the configuration in which rotation of the camera body 2 is mechanically restricted may be employed.

In the foregoing embodiment, the position of the camera body 2 is detected by the photo sensors 68, but the present disclosure is not limited to such a configuration. For example, the position of the camera body 2 may be detected by a magnet and a hall sensor, or may be detected in such a manner that a second case 14 made of metal is used to detect eddy-current loss or an electrostatic capacitance change. Image detection of the first case 13 by the camera body 2 may be used.

Since the curvature radius of the cover 11 is less than that of the first case 13, the step 15 is formed at the boundary between the cover 11 and the first case 13. However, the step 15 is not limited to such a configuration. For example, a step may be formed in the first case 13. Specifically, a circular protrusion may be formed parallel to the opening 12a near the opening 12a of the first case 13. Moreover, although the step 15 contacts the driver element(s) 42, the configuration in which a member(s) other than the driver elements 42 contacts the step 15 may be employed. For example, movement of the camera body 2 may be restricted by contact of part of the movable frame 21 with the step 15.

Rotation restriction of the camera body 2 by the photo sensors 68 and rotation restriction of the camera body 2 by the step 15 limit rotation of the camera body 2 within such a range that each of the driver elements 42 does not contact the inner surface of the cover 11. However, the present disclosure is not limited to such a configuration. Rotation of the camera body 2 may be limited within such a range that the shooting range S of the camera body 2 is limited within the opening 12a of the case 12.

Regardless of whether or not the boundary between the cover 11 and the case 12 is in the shooting range S, the rotation range of the camera body 2 may be limited such that the driver element(s) 42 does not enter the region defined by the track of the shooting range S. That is, in an imaging apparatus 100 for shooting an image of an object, which includes an outer shell 1 having an inner spherical zone surface and an imager (camera body 2) configured to be movable inside the outer shell 1 and to shoot an image of an object outside the outer shell 1 through the outer shell 1, the imager may include contact parts (driver elements 42) contacting an inner surface of the outer shell 1 upon movement of the imager inside the outer shell 1, and a movement range of the imager may be limited such that the contact part(s) does not enter a region defined by a movement track of a shooting range S of the imager in association with movement of the imager. Of the inner surface of the outer shell 1, part defined by the movement track of the shooting range S of the imager (camera body 2) does not contact the driver element(s) 42. Thus, formation of abrasion marks in such part by the driver element(s) 42 can be reduced or prevented. That is, in the region defined by the movement track of the shooting range S, formation of abrasion marks by the driver element(s) 42 can be reduced or prevented.

In the foregoing embodiment, the reflective film 14a is formed only in the opening edge part of the second case 14, but the present disclosure is not limited to such a configuration. For example, the reflective film 14a may be formed across the entirety of the inner surface of the second case 14. This allows position detection across the entirety of a movement region of the camera body 2. Alternatively, the reflective film 14a may be formed in part other than the second case 14. That is, the reflective film 14a may be formed at positions corresponding to the photo sensors 68 so as to face the photo sensors 68. For example, the reflective film 14a may be formed in the first case 13 or the cover 11.

As described above, the technique disclosed herein is useful for the imaging apparatus including the imager arranged inside the case having the inner spherical zone surface.

What is claimed is:

1. An imaging apparatus for shooting an image of an object, comprising:
a case formed with an opening and having an inner spherical zone surface; and
an imager configured to be movable inside the case and to shoot the image of the object outside the case through the opening,
wherein the imager includes an imager body and at least two drivers configured to freely move the imager body within the case, and
a shooting range of the imager is limited within the opening.

2. The imaging apparatus of claim 1, further comprising:
a cover covering the opening,
wherein the imager is configured to move inside the case in a state in which the imager contacts an inner surface of the case, and
movement of the imager is limited within such a range that the imager does not contact an inner surface of the cover.

3. The imaging apparatus of claim 1, further comprising:
a position detector configured to detect a position of the imager; and
a controller configured to control movement of the imager,
wherein the controller limits, based on a detection result of the position detector, the movement of the imager within a predetermined range such that the shooting range of the imager is limited within the opening.

4. The imaging apparatus of claim 3, further comprising:
a restrictor configured to restrict the movement of the imager when the imager moves outside the predetermined range.

5. The imaging apparatus of claim 2, further comprising:
a restrictor configured to restrict the movement of the imager such that the imager does not contact the inner surface of the cover.

6. The imaging apparatus of claim 1, wherein
the inner surface of the cover defines a spherical-sector shape having a curvature substantially identical to that of the inner surface of the case.
